(19) United States
(12) Patent Application Publication
(10) Pub. No.: US 2017/0092919 A1
(43) Pub. Date: Mar. 30, 2017

(54) NONAQUEOUS ELECTROLYTE SECONDARY BATTERY SEPARATOR AND NONAQUEOUS ELECTROLYTE SECONDARY BATTERY

(71) Applicant: Sumitomo Chemical Company, Limited, Tokyo (JP)

(72) Inventor: Toshihiko OGATA, Osaka (JP)

(21) Appl. No.: 15/273,873

(22) Filed: Sep. 23, 2016

(30) Foreign Application Priority Data
Sep. 24, 2015 (JP) 2015-187254

(51) Int. Cl. H01M 2/16; H01M 2/34

(52) U.S. Cl. CPC H01M 2/1653; H01M 2/348; H01M 2220/30; H01M 2200/10

(57) ABSTRACT

A nonaqueous electrolyte secondary battery separator is provided. The nonaqueous electrolyte secondary battery separator is made of a porous film containing a polyolefin-based resin as a main component and has a 60-degree specular gloss of 6% to 30%. The nonaqueous electrolyte secondary battery separator suppresses a deterioration in cycle characteristic, without including another porous layer in addition to the porous film containing the polyolefin-based resin as a main component.

This Nonprovisional application claims priority under 35 U.S.C. §119 on Patent Application No. 2015-187254 filed in Japan on Sep. 24, 2015, the entire contents of which are hereby incorporated by reference.

### TECHNICAL FIELD

The present invention relates to a nonaqueous electrolyte secondary battery separator and a nonaqueous electrolyte secondary battery.

### BACKGROUND ART

Nonaqueous electrolyte secondary batteries (hereinafter referred to as “nonaqueous secondary battery”) such as a lithium secondary battery are currently in wide use as batteries for devices such as a personal computer, a mobile telephone, and a portable information terminal.

A nonaqueous secondary battery, typified by a lithium secondary battery, has a high energy density and may thus let a large current flow and generate heat in a case where a breakage in the battery or in the device using the battery has caused an internal or external short circuit. This risk has created a demand that a nonaqueous secondary battery should prevent more than a certain level of heat generation to ensure a high level of safety.

Safety of a nonaqueous secondary battery is typically ensured by imparting to the nonaqueous secondary battery a shutdown function, that is, a function of, in a case where there has been abnormal heat generation, preventing passage of ions between the cathode and the anode with use of a separator to prevent further heat generation. More specifically, a nonaqueous secondary battery typically includes, between the cathode and the anode, a separator that has a function of, in a case where, for example, an internal short circuit between the cathode and the anode has caused an abnormal current to flow through the battery, prevent that current and prevent (shutdown) the flow of an excessively large current for prevention of further heat generation. The separator is typically made of a filmy porous base material whose main component is, for example, a polyolefin-based resin which melts at approximately 80° C. to 180° C. when abnormal heat generation occurs.

There have been known, as a porous base material containing a. polyolefin-based resin as a main component, (i) a porous film having micropores and (ii) a nonwoven fabric (see Patent Literature 1) made of polyolefin fibers. However, the nonwoven fabric has a greater pore diameter, a larger number of through holes, a higher porosity, and lower mechanical strength, as compared with the porous film. Therefore, the porous film is mainly employed as the porous base material, in consideration of insulation reliability and safety against an internal short circuit.

However, there is a problem that since the porous film containing a polyolefin as a main component has a pore diameter smaller than that of the non woven fabric, a deterioration in cycle characteristic occurs. In order to solve the problem, Patent Literature 2 discloses a technique of designing a pore diameter d_{BET}, which is obtained by a specific surface area measurement by the BET method, and a value obtained by dividing d_{BET} by a pore diameter d_{BUBBLE}, which is obtained by the bubble point method, to fall under respective specific ranges. This improves wettability and retainability of the porous film, with respect to an electrolyte solution and improves the cycle characteristic, accordingly.

### CITATION LIST

### Patent Literatures

Patent Literature 1

Japanese Patent Application Publication, Tokukai, No. 2014-11041 (Publication Date: Jan. 20, 2014)

Patent Literature 2

Japanese Patent Application Publication, Tokukai, No. 2012-48987 (Publication Date: Mar. 8, 2012)

Patent Literature 3

Japanese Patent Application Publication, Tokukai, No. 2005-294216 (Publication Date: Oct. 20, 2005)

Patent Literature 4

Japanese Patent Application Publication, Tokukai, No. 2014-17264 (Publication Date: Jan. 30, 2014)

### SUMMARY OF INVENTION

### Technical Problem

However, according to the technique disclosed in Patent Literature 2, d_{BET}/d_{BUBBLE} is greater than 1, so that there are many pores each having a diameter smaller than an average pore diameter. This makes it impossible to sufficiently address a problem that the cycle characteristic is deteriorated by an increase in internal resistance caused by an intrusion of an electrolyte-insoluble component (a solid or gas), which is generated at. an electrode by repeated charge and discharge of the battery, into the pores and a resulting blockage of the pores.

The present invention has been accomplished in view of the problem, and an object of the present invention is to provide a nonaqueous secondary battery separator which is made of a porous film and suppresses a deterioration in cycle characteristic caused by an increase in internal resistance.

### Solution to Problem

The inventors of the present, invention have focused for the first time on a fact that a 60 degree specular gloss of a porous film containing a polyolefin-based. resin as a main component relates to a cycle characteristic of a nonaqueous secondary battery including the porous film as a nonaqueous secondary battery separator. The inventors of the present invention have completed the present invention by finding that it is possible to suppress a deterioration in cycle characteristic of the nonaqueous secondary battery by adjusting the 60-degree specular gloss of the porous film to fall within a predetermined range.

Note that Patent Literature 1 discloses a separator made of a non woven fabric which has a 60-degree specular gloss defined. However, an object of Patent Literature 1 is to prevent a short circuit, which is a problem arising in the nonwoven fabric having a pore diameter greater than that of a porous film, and in Patent Literature 1, the specular gloss is defined in order to attain the object. Meanwhile, the present indention defines the specular gloss of the porous film in order to prevent a deterioration in cycle characteristic, which is a problem specific to the porous film having a pore diameter smaller than that of the nonwoven fabric. Accordingly, the present invention has a technical idea which totally differs in object and configuration from Patent Literature 1.

Patent Literature 3 discloses a secondary battery (i) which includes an electrode, a separator which is a microporous sheet made of a polyolefin-based resin, and a porous film adhered to a surface of the electrode and (ii) in which an 85-degree specular gloss is defined with respect to the porous film. Patent Literature 4 discloses a technique in which a 60-degree specular gloss is defined with respect to a separator which is obtained by applying, to a polyethylene microporous film, a composition containing insulating fine particles and an organic binder. However, according to each of the techniques disclosed in respective Patent Literatures 3 and 4, another layer (i.e., the porous film in Patent Literature 3, and a layer of the composition containing the insulating fine particles and the organic binder in Patent Literature 4) is provided in addition to the microporous sheet (microporous film) and a specular gloss of the another layer is defined. That is, the techniques disclosed in Patent Literatures 3 and 4 do not define a specular gloss of the porous film itself containing a polyolefin-based resin as a main component. Further, Patent Literature 3 has an object of providing a porous film which is thin, uniform, and excellent in flexibility. Patent Literature 4 has an object of providing a secondary battery which is capable of preventing a short circuit and has excellent reliability. That is, Patent Literatures 3 and 4 each do not define the specular gloss in order to suppress a deterioration in cycle characteristic of a nonaqueous secondary battery. As described above, the present invention is an invention having a technical idea which totally differs in object and configuration from those disclosed in Patent Literatures 3 and 4.

In order to attain the object, a nonaqueous electrolyte secondary battery separator in accordance with the present invention includes a porous film containing a polyolefin-based resin as a main component, the nonaqueous electrolyte secondary battery separator having a 60-degree specular gloss of 6% to 30%.

The porous film preferably has an average pore diameter of not more than 0.14 μm. Further, the porous film preferably has piercing strength of not less than 2 N. Furthermore, the porous film preferably has a 60-degree specular gloss of 15% to 20%.

Further, in order to attain the object, a laminated body in accordance with the present invention includes the nonaqueous electrolyte secondary battery separator and an electrode sheet.

### Advantageous Effects of Invention

The present invention brings about an effect of suppressing a deterioration in cycle characteristic caused by an increase m internal resistance, in a separator made of a porous film.

### DESCRIPTION OF EMBODIMENTS

The description below deals with an embodiment of the present invention. The present invention is, however, not limited to such an embodiment. Further, the present invention is not limited to the description of the arrangements below, but may be altered in various ways by a skilled person within the scope of the claims. Any embodiment based on a proper combination of technical means disclosed in different embodiments is also encompassed in the technical scope of the present invention. In the Description, any numerical range expressed as “A to B” means “not less than A and not greater than B” unless otherwise stated.

[1. Nonaqueous Secondary Battery Separator]

A nonaqueous secondary battery separator in accordance with the present invention is provided between a cathode and an anode in a nonaqueous secondary battery and is made of a filmy porous film containing a polyolefin-based resin as a main component.

The porous film only needs to be a porous and filmy base material (i.e., a polyolefin-based porous base material) containing a polyolefin-based resin as a main component. That is, the porous film is a film that (i) has therein pores connected to one another and (ii) allows gas or a liquid to pass therethrough from one surface to the other surface. In other words, the porous film in accordance with the present invention is a film having pores and differs from a non woven fabric in which fibers are piled up on one another.

The porous film can be arranged such that in a case where the nonaqueous secondary battery generates heat, the porous film is melted so as to render a non-aqueous secondary battery separator non-porous. Thus, the porous film can provide a shutdown function to the non-aqueous secondary battery separator. The porous film can be made of a single layer or a plurality of layers.

The porous film has a volume-based porosity of preferably 0.2 to 0.8 (20% by volume to 80% by volume), and more preferably 0.3 to 0.75 (30% by volume to 75% by volume), in order to allow the separator to (i) retain a larger amount of electrolyte solution and (ii) achieve a function of reliably preventing (shutting down) the flow of an excessively large current at a lower temperature. The porous film has pores each having an average diameter (an average pore diameter) of preferably 0.14 μm or less, and more preferably 0.1 μm or less, in order to, in a case where the porous film is used as a separator, achieve sufficient ion permeability and prevent particles from entering the cathode and/or the anode.

The average pore diameter of the porous film is controlled through, for example, a method of, in a case of reducing the pore diameter, (i) uniformizing the dispersion state of a pore forming agent such as an inorganic filler or of a phase separating agent during production of the porous film, (ii) using, as a pore forming agent, an inorganic filler having smaller particle sizes, (iii) drawing the porous film in a state where the porous film contains a phase separating agent, or (iv) drawing the porous film at a low extension magnification. The porosity of the porous film is controlled through, for example, a method of, in a case of producing a porous film having a high porosity, (i) increasing the amount of a pore forming agent such as an inorganic filler or of a phase separating agent relative to the polyolefin-based resin, (ii) drawing the porous film after the phase separating agent has been removed, or (iii) drawing the porous film at a high extension magnification.

A decrease in the average pore diameter of the porous film should increase a capillary force, which is presumed to serve as a driving force for introducing the electrolyte solution into pores inside the polyolefin base material. Furthermore, a smaller average pore diameter can subdue generation of dendrites of lithium metal.

Further, an increase in the porosity of the porous film should decrease the volume of a portion of the polyolefin base material which portion contains a polyolefin that cannot be permeated by the electrolyte solution.

The porous film has a piercing strength of preferably not less than 2N, and more preferably not less than 3N. The porous film having excessively small piercing strength may allow cathode active material particles and anode active material particles to pierce the separator so that a short circuit occurs between the cathode and the anode, for example, in a case where (i) an operation of stacking the cathode, the anode, and the separator and then rolling up the stack thus obtained Is carried out in a battery assembly process, (ii) an operation of pressing the stack thus rolled up is carried out in the battery assembly process, or (iii) an external pressure is applied to the battery. The porous film has piercing strength of preferably not more than 10N, and more preferably not more than 8N.

It is essential that the porous film contains a polyolefin-based resin component at a proportion of not less than 50% by volume with respect to whole components contained in the porous film. Such a proportion of the polyolefin-based resin component is preferably not less than 90% by volume, and more preferably not less than 95% by volume. The porous film preferably contains, as the polyolefin-based resin component, a high molecular weight component having a weight-average molecular weight of 5×10⁵ to 15×10⁶. The porous film particularly preferably contains, as the polyolefin-based resin component, a polyolefin-based resin component having a weight-average molecular weight of 1,000,000 or more. This is because that a whole of the porous film (i.e., nonaqueous secondary battery separator) achieves higher strength.

Examples of the polyolefin-based resin include high molecular weight homopolymers or copolymers produced through polymerization of ethylene, propylene, 1-butene, 4-methyl-1-pentene, 1-hexene, and/or the like. The porous film can be a layer containing only one of these polyolefins and/or a layer containing two or more of these polyolefins. Among these, a high molecular weight polyethylene containing ethylene as a main component is particularly preferable. Note that the porous film can contain another component which is not a polyolefin, as long as the another component does not impair the function of the layer.

The porous film has an air permeability normally in a range of 30 sec/100 cc to 500 sec/100 cc, and preferably in a range of 50 sec/100 cc to 300 sec /100 cc, in terms of Gurley values. A porous film having an air permeability within such achieves sufficient ion permeability in a case where the porous film is used in the separator.

The porous film has a thickness of preferably 4 μm to 40 μm. and more preferably a thickness of 7 μm to 30 μm. The porous film has a weight per unit area of normally 4 g/m² to 20 g/m², and preferably 5 g/m² to 12 g/m². This is because that a porous film having such a weight per unit area enables to provide suitable strength, thickness, handling easiness, and weight and is also possible to enhance a weight energy density and/or a volume energy density of the nonaqueous secondary battery in a case where the porous film is used in the separator of the nonaqueous secondary battery.

The inventors of the present invention have diligently studied and found that in a case where the porous film has a 60-degree specular gloss of 6% to 30%, it is possible to suppress a deterioration in cycle characteristic of the nonaqueous secondary battery having the porous film as a separator. Note that the 60-degree specular gloss of the porous film indicates a gloss which, is obtained in a case where an incident angle and a light-receiving angle of the porous film are each 60° and the 60-degree specular gloss is measured by a method defined in JIS Z8741. A specular gloss of the porous film is a parameter related to denseness, uniformity, and the like of the porous film.

The specular gloss is based on an amount of reflected light. The porous film has openings on a surface thereof. Accordingly, incident light for measuring the specular gloss of the porous film enters an inside of the porous film.

The light which has entered the inside of the porous film is reflected (mirror-reflected or diffuse-reflected) or scattered on surfaces of the resin which, surfaces constitute inner walls of holes inside the porous film. The light thus reflected or scattered is partially emitted, as internally reflected light, from the surface of the porous film to outside.

It has been known that an amount of light reflected inside a porous body is influenced by a size and shape of a void in the porous body (see Takehiro YAMADA, “Study for Characteristic of Microcellular Plastic”, Saitama Industrial Technology Center Research Report, Vol. 4 (2006); and National Institute of Information and Communications Technology, “Research and development of new reflective plate for cost reduction of liquid crystal display device”, Research and development result report for FY 2006 (April 2007)).

Accordingly, a person skilled in the art will be able to sufficiently understand, based on the Description, that the specular gloss reflects a state of an entire inside of the separator.

In a case where the porous film has a 60-degree specular gloss of less than 6%, the porous film has low uniformity, and thus has non-uniform ion permeability. As a result, deterioration of the porous film caused by repeated charge and discharge of the nonaqueous secondary battery progresses faster, which leads to a deterioration in cycle characteristic. Accordingly, in a case where the porous film has a 60-degree specular gloss of not less than 6%, it is possible to suppress a deterioration in cycle characteristic caused, by non-uniformity of the porous film.

Meanwhile, in a case where the porous film has a 60-degree-specular gloss of more than 30%, the porous film has an excessively high denseness, and thus the pores are blocked by an insoluble byproduct and/or air bubbles caused by charge and discharge. This leads to an increase in battery internal resistance. Further, there is less space for an electrolyte solution to be retained at an interface between the porous film and art electrode, so that the electrolyte solution is more likely to be partially dried up due to repeated charge and discharge. This causes a decrease in ion permeability, which leads to a deterioration in. cycle characteristic. Accordingly, the porous film having a 60-degree specular gloss specular gloss of not more than 30% can prevent the cycle characteristic from deteriorating due to (i) the blockage of the pores by the insoluble byproduct and/or (ii) the drying up of the electrolyte solution at the interface between the porous film and the electrode.

The porous film has a 60-degree specular gloss of preferably not less than 10%, and more preferably not less than 15%. Further, the porous film has a 60-degree specular gloss of preferably not more than 25%, and more preferably not more than 20%.

The following description will discuss a method for producing the porous film. For example, a porous film having a 60-degree specular gloss of 6% to 30% can be produced by treating, by use of sandpaper or the like, a surface of a sheet obtained by a method (e.g. Japanese Patent Application Publication, Tokukaihei, No. 7-29563 A (1995)) of (i) adding a plasticizing agent to a thermoplastic resin to shape the thermoplastic resin into a film and then (ii) removing the plasticizing agent with use of an appropriate solvent. Alternatively, such a porous film may be produced by a publicly known treatment such as (i) a chemical treatment involving an acid, an alkali, an organic solvent, or the like, (ii) a corona treatment, or (iii) a plasma treatment.

Specifically, in a case of, for example, producing a porous film with use of a polyolefin resin containing (i) an ultra high molecular weight polyethylene and (ii) a low molecular weight polyolefin having a weight-average molecular weight of 10,000 or less, such a porous film is, in terms of production cost, preferably produced through the method including the steps of:

(1) kneading (i) 100 parts by weight of the ultra high molecular weight polyethylene, (ii) 5 parts by weight to 200 parts by weight of the low molecular weight polyolefin having a weight-average molecular weight of 10,000 or less, and (iii) 100 parts by weight to 400 parts by weight of an inorganic filler such as calcium carbonate to produce a polyolefin resin composition;

(2) shaping the polyolefin resin composition into a sheet;

(3) removing the inorganic filler from the sheet produced in the step (2);

(4) drawing the sheet produced in the step (3); and

(5) producing a porous film having a 60-degree specular gloss of 6% to 30%, by treating, by use of sandpaper or the like, a surface of the sheet produced in the step (4).

[2. Nonaqueous Secondary Battery]

A nonaqueous secondary battery in accordance with the present invention achieves an electromotive force through doping and dedoping with lithium. The nonaqueous secondary battery in accordance with the present invention only needs to include a laminated body in which a cathode sheet, an anode sheet, and the above-described nonaqueous secondary battery separator in accordance with the present invention are laminated, and is not particularly limited in other arrangements. The nonaqueous secondary battery includes (i) a battery element made of a structure (a) including the anode sheet and the cathode sheet facing each other via the above-described nonaqueous secondary battery separator and (b) containing the electrolyte solution and (ii) an exterior member including the battery element. The nonaqueous secondary battery is suitably applicable to a nonaqueous electrolyte secondary battery, and is particularly applicable to a lithium ion secondary battery. Note that the doping means storage, support, absorption, or insertion, and means a phenomenon in which lithium ions enter an active material of the electrode (e.g., the cathode), A nonaqueous secondary battery produced so as to include the above-described nonaqueous secondary battery separator in accordance with the present invention excels in handling easiness of the separator, and thus has a high production yield.

The cathode sheet may be achieved as an active material layer which (i) is formed on a current collector and (ii) includes a cathode active material and a binder resin. The active material layer may further include a conductive auxiliary agent.

Examples of the cathode active material include a lithium-containing transition metal oxide, specific examples of which include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂, and LiAl_{1/4}Ni_{3/4}O₂.

Examples of the binder resin include a polyvinylidene fluoride-based resin.

Examples of the conductive auxiliary agent include carbon materials such as acetylene black, Ketjenblack, and graphite powder.

Examples of the current collector include aluminum foil, titanium foil, and stainless steel foil each having a thickness of 5 μm to 20 μm.

The anode sheet may be achieved as an active material layer which (i) is formed on a current collector and (ii) includes an anode active material and a binder resin. The active material layer may further include a conductive auxiliary agent. Examples of the anode active material include a material capable of electrochemical storage of lithium. Specific examples of such a material include a carbon material; and an alloy of (i) lithium and (ii) silicon, tin, aluminum, or the like.

Examples of the binder resin include a polyvinylidene fluoride-based resin and styrene-butadiene rubber. The separator of the present invention is able to ensure sufficient adhesion to the anode even if the anode includes styrene-butadiene rubber as the anode binder.

Examples of the conductive auxiliary agent include carbon materials such as acetylene black, Ketjenblack, and graphite powder.

Examples of the current collector include copper foil, nickel foil, and stainless steel foil each having a thickness of 5 μm to 20 μm. Instead of the anode described above, metallic lithium foil may be employed as the anode.

The electrolyte solution is a solution made of a nonaqueous solvent in which a lithium salt is dissolved. Examples of the lithium salt include LiPF₆, LiBF₄, and LiClO₄.

Examples of the nonaqueous solvent include all solvents normally used in a nonaqueous secondary battery, and are not limited to the above mixed solvent (ethyl methyl carbonate, diethyl carbonate, and ethylene carbonate in volume ratio of 50:20:30).

Examples of the nonaqueous solvent include cyclic carbonate such as ethylene carbonate, propylene carbonate, fluoroethylene carbonate, and difluoroethylene carbonate; chain carbonate such as dimethyl carbonate, diethyl carbonate, ethyl methyl carbonate, and fluorine substituents thereof; and cyclic ester such as γ-butyrolactone and γ-valerolactone, The present invention may use only (i) one kind of solvent or (ii) two or more kinds of solvents in combination selected from the above.

The electrolyte solution is preferably the one obtained by (i) preparing a solvent through mixing of cyclic carbonate and chain carbonate at a mass ratio (cyclic carbonate/chain carbonate) of 20/80 to 40/60 (more preferably, 30/70) and (ii) dissolving in the solvent a lithium salt at a concentration of 0.5M to 1.5M.

Examples of the exterior member include a metal can and a pack which is made of an aluminum-laminated film. Examples of the shape of the battery include a polygon, a cylinder, and a coin shape.

It is possible to produce the nonaqueous secondary battery by, for example, (i) causing the electrolyte solution to permeate the laminated body including the cathode sheet, the anode sheet, and the above-described separator which is disposed between the cathode sheet and the anode sheet, (ii) causing the laminated body to be accommodated in the exterior member (e.g., the pack made of the aluminum-laminated layer film), and (iii) pressing the laminated body via the exterior member. It is preferable to perform the pressing while the separator and the electrode are heated (hot pressing) in order to further enhance adhesion between the electrode and the separator.

A manner how the separator is disposed between the cathode sheet and the anode sheet may be (i) a manner (so-called stack system) in which at least one cathode sheet, at least one separator, and at least one anode sheet are stacked in this order or (ii) a manner in which, a cathode sheet, a separator, an anode sheet, and a separator are stacked in this order and the stack thus obtained is rolled up in a direction along a length of the stack.

### Examples

The following description will discuss the present invention with reference to Examples, but the present invention is not limited to this.

<Measurement of Specular Gloss Of Separator>

A specular gloss of a separator was measured by use of a gloss meter (manufactured by NIPPON DENSHOKU INDUSTRIES Co., LTD.; PG-IIM type) in .such a manner that (i) five sheets of KB paper (manufactured by KOKUYO Co., Ltd.; product No. KB-39N) were stacked on one another, (ii) the separator whose specular gloss was to be measured was placed on top of the five sheets of KB paper, and (iii) the measurement was carried out with an incident angle and a light-receiving angle of the separator each set to 60°.

Note that, if necessary, for example, in a case where a matter such, as resin powder and an inorganic matter is adhered to a surface of the separator, it is possible to carry out, before the measurement of the specular gloss, a pre treatment of the separator, for example, by (i) immersing the separator in an organic solvent such as diethyl carbonate (DEC) and/or water and washing off the matter thus adhered and then (ii) drying off the organic, solvent and/or water.

<Measurement of Piercing Strength>

A porous film was fixed with a washer of 12 mmΦ by use of a handy-type compression tester (KATO TECH CO., LTD.; model No. KES-G5). Piercing strength of the porous film was defined as a maximum stress (N) obtained by piercing the porous film with a pin at 200 mm/msn. The pin used in the measurement had a pin diameter of 1 mmΦ and a tip radius of 0.5 R.

[Production of Separator]

Nonaqueous secondary battery separators in accordance with Examples 1 through 3 and Comparative Examples 1 and 2 were produced as below.

### Example 1

A surface of a polyethylene porous film (thickness: 16 μm; porosity; 39% by volume; 60-degree specular gloss: 33%) was processed by use of sandpaper (manufactured by Nihon Kenshi Co., Ltd.; waterproof abrasive paper “WTCC-S”; grit size: 100) to achieve a 60-degree specular gloss of 19%, and the polyethylene porous film thus processed was used as the nonaqueous secondary battery separator in accordance with Example 1. Piercing strength of the nonaqueous secondary battery separator in accordance with Example 1 was measured to be 4.5 N.

### Example 2

A surface of a polyethylene porous film (thickness: 16 μm; porosity: 39% by volume; 60-degree specular gloss: 33%) was processed by use of sandpaper (manufactured by Nihon Kenshi Co., Ltd.; waterproof abrasive paper “WTCC-S”; grit, size: 100) to achieve a 60-degree specular gloss of 7%, and the polyethylene porous film thus processed was used as the nonaqueous secondary battery separator in accordance with Example 2. Piercing strength of the nonaqueous secondary battery separator in accordance with Example 2 was measured to be 4.2 N.

### Example 3

A surface of a polyethylene porous film (thickness: 16 μm; porosity: 39% by volume; 60-degree specular gloss: 33%) was processed by use of sandpaper (manufactured by Nihon Kenshi Co., Ltd.; waterproof abrasive paper “WTCC-S”; grit size: 100) to achieve a 60-degree specular gloss of 29%, and the polyethylene, porous film thus processed was used as the nonaqueous secondary battery separator in accordance with Example 3. Piercing strength of the nonaqueous secondary battery separator in accordance with Example 3 was measured to be 4.2 N.

### Comparative Example 1

A porous film used as the nonaqueous secondary battery separator in accordance with Comparative Example 1 was identical to the polyethylene porous film used in Example 1, except that a surface of the porous film was unprocessed. Piercing strength of the nonaqueous secondary battery separator in accordance with Comparative Example 1 was measured to be 4.2 N.

### Comparative Example 2

A porous film used as the nonaqueous secondary battery separator in accordance with Comparative Example 2 was identical to the polyethylene porous film used in Example 1, except that after the surface of the porous film was processed with sandpaper (manufactured by Nihon Kenshi Co., Ltd.; waterproof abrasive paper “WTCC-S”; grit size: 100), folds were formed in the porous film so as to achieve a 60-degree specular gloss of 5%. Piercing strength of the nonaqueous secondary battery separator in accordance with Comparative Example 2was measured to be 4.5 N.

<Production of Nonaqueous Electrolyte Secondary Battery>

Next, using the nonaqueous secondary battery separators in accordance with Examples 1 through 3 and Comparative Examples 1 and 2 which were produced as above, nonaqueous secondary batteries were produced as follows.

(Cathode)

A commercially available cathode which was produced by applying LiNi_{0.5}Mn_{0.3}Co_{0.2}O₂ /conductive material/PVDF (weight ratio 92/5/3) to an aluminum foil was used. The aluminum foil of the cathode was cut so that a portion of the cathode where a cathode active material layer was formed had a size of 40 mm×35 mm and a portion where the cathode active material layer was not formed, with a width of 13 mm, remained around that portion. The cathode active material layer had a thickness of 58 μm and density of 2.50 g/cm³.

(Anode)

A commercially available anode produced by applying graphite/styrene-1,3-butadiene copolymer/carboxymethyl cellulose sodium (weight ratio 98/1/1) to a copper foil was used. The copper foil of the anode was cut so that a portion of the anode where an anode active material layer was formed had a size of 50 mm×40 mm, and a portion where the anode active material layer was not formed, with a width of 13 mm, remained around that portion. The anode active material layer had a thickness of 49 μm and density of 1.40 g/cm³.

(Assembly)

In a laminate pouch, the cathode, the nonaqueous secondary battery separator, and the anode were laminated (provided) in this order so as to obtain a nonaqueous electrolyte secondary battery member. In this case, the cat bode and the anode were positioned so that a whole of a main surface of the cathode active material layer of the cathode was included in a range of a main surface (overlapped the main surface) of the anode active material layer of the anode.

Subsequently, the nonaqueous electrolyte secondary battery member was put in a bag made by laminating an aluminum layer and a heat seal layer, and 0.25 mL of a nonaqueous electrolyte, solution was poured into the bag. The nonaqueous electrolyte solution was an electrolyte solution at 25° C. obtained by dissolving LiPFe with a concentration of 1.0 mole per liter in a mixed solvent of ethyl methyl carbonate, diethyl carbonate, and ethylene carbonate in a volume ratio of 50:20:30. The bag was heat-sealed while a pressure inside the bag was reduced, so that a nonaqueous secondary battery was produced.

### <Cyclic Test>

A new nonaqueous secondary battery which had not been subjected to any cycle of charge/discharge was subjected to 4 cycles of initial charge/discharge. Each cycle of the initial charge/discharge was performed under conditions that the temperature was 25°C, the voltage range was 4.1 V to 2.7 V, and the current value was 0.2 C (1C is defined as a value of a current at which a rated capacity based on a discharge capacity at 1 hour rate is discharged for 1 hour. The same is applied hereinafter).

Subsequently, the nonaqueous secondary battery was subjected to 200 cycles of charge/discharge. Each cycle of the charge/discharge was performed under conditions that the temperature was 55° C., the voltage range was 4.2 V to 2.7 V, and constant currents were a charge current value of 1 C and a discharge current value of 1 C. Then, an internal resistance increase rate after 200 cycles was calculated in accordance with a formula below, where a discharge IR drop is a resistance value of the nonaqueous secondary battery which resistance value is obtained 10 seconds after start of discharge.

Internal resistance increase rate (%)=(discharge IR drop at 200th cycle/discharge IR drop at first cycle after initial charge and discharge)×100

The result is shown in Table 1.

TABLE 1

| | | | Internal |
|---|---|---|---|
| | | | resistance |
| | 60-degree | | increase rate |
| | specular | Piercing | after 200 |
| | gloss | strength | cycles |
| Example 1 | 19% | 4.5N | 292% |
| Example 2 | 7% | 4.2N | 325% |
| Example 3 | 29% | 4.2N | 326% |
| Comparative | 33% | 4.2N | 354% |
| Example 1 | | | |
| Comparative | 5% | 4.5N | 453% |
| Example 2 | | | |

As shown in Table 1, it was confirmed that, in the nonaqueous secondary battery including the nonaqueous secondary battery separator in accordance with Comparative Example 1, which nonaqueous secondary battery separator had a 60-degree specular gloss of more than 30%, the internal resistance increase rate after 200 cycles was not less than 350%, that is, an internal resistance was remarkably increased. It can be assumed that this is because the porous film having the 60-degree specular gloss of more than 30% had an excessively high denseness, and ion permeability was accordingly decreased due to (i) blockage of pores with an insoluble byproduct and/or air bubbles caused by charge and discharge and/or (ii) a deterioration in function of retaining an electrolyte solution at an interface between the separator and an electrode.

It was confirmed that, in the nonaqueous secondary battery including the nonaqueous secondary battery separator in accordance with Comparative Example 2, which nonaqueous secondary battery separator had a 60-degree specular gloss of less than 6%, the internal resistance increase rate after 200 cycles was not less than 450%, that is, an internal resistance was remarkably increased. It can be assumed that this is because the porous film having the 60-degree specular gloss of less than 6% had low uniformity> and thus had non-uniform ion permeability.

Meanwhile, it was confirmed that, in the nonaqueous secondary battery including the nonaqueous secondary battery separator in accordance with each of Examples 1 through 3, which nonaqueous secondary battery separator had a 60-degree specular gloss of 6% to 30%, the internal resistance increase rate after 200 cycles was less than 330%, and the nonaqueous secondary battery separator in accordance with Examples 1 through 3 therefore makes it possible to suppress a cycle characteristic caused by an increase in internal resistance.

1. A nonaqueous electrolyte secondary battery separator comprising
a porous film containing a polyolefin-based resin as a main component,
the nonaqueous electrolyte secondary battery separator having a 60-degree specular gloss of 8% to 30%.

2. The nonaqueous electrolyte secondary battery separator as set forth in claim 1, wherein the porous film has an average pore diameter of not more than 0.14 μm.

3. The nonaqueous electrolyte secondary battery separator as set forth in claim 1, wherein the porous film has piercing strength of not less than 2 N.

4. The nonaqueous electrolyte secondary battery separator as set forth in claim 1, wherein the nonaqueous electrolyte secondary battery separator has a 60-degree specular gloss of 15% to 20%.

5. A nonaqueous electrolyte secondary battery comprising a nonaqueous electrolyte secondary battery separator recited in claim 1.
